(19) United States
(12) Patent Application Publication
(10) Pub. No.: US 2009/0264585 A1
(43) Pub. Date: Oct. 22, 2009

(54) Emulsion polymerization of hydrophobic monomers

(76) Inventors: Kostas S. Avramidis, Apex, NC (US); David R. Bassett, Swannanoa, NC (US)

Correspondence Address: The Dow Chemical Company, Intellectual Property Section, P.O. Box 1967, Midland, MI, 48641-1967, US

(21) Appl. No.: 11/665,244

(22) PCT Filed: Oct. 12, 2005
(86) PCT No.: PCT/US05/36550

§ 371 Date: Jun. 26, 2009

Related U.S. Application Data
(60) Provisional application No. 60/619,120, filed on Oct. 15, 2004.

(51) Int. Cl. C08L 31/02

(52) U.S. Cl. 524/563

(57) ABSTRACT

Copolymers of hydrophobic higher branched vinyl esters, and a polymerization process for polymerization of hydrophobic monomers in the presence of surfactants having low critical micelle concentration.

### BACKGROUND OF THE INVENTION

The present invention relates to a method for polymerizing hydrophobic monomers.

One of the main requirements for protective coatings is the ability to confer water resistance to painted substrates. Since the binder is a major part of most coatings, current research in emulsion polymer design is aimed at providing more effective barrier properties by increasing the hydrophobic nature of the polymers produced. That, in turn, requires means for effectively and efficiently polymerizing hydrophobic monomers.

Latex paint coatings typically are applied to substrates and dried to form continuous films for decorative purposes as well as to protect the substrate. Such paint coatings are often applied to architectural interior or exterior surfaces under conditions where the coatings are sufficiently fluid to form a continuous paint film and dry at ambient temperatures. Exterior durability requires a high degree of hydrophobicity to protect the film from water penetration and subsequent coating failure. That, in turn, also requires means for effectively and efficiently polymerizing hydrophobic monomers.

Two types of polymers commonly used in formulating latex paints are: (i) an all acrylic system, e.g., copolymers of methyl methacrylate, butyl acrylate or 2-ethylhexyl acrylate with small amounts of functional monomers, such as carboxylic acids; and (ii) vinyl acetate-based copolymers, usually in combination with a small proportion of the above-mentioned lower alkyl acrylates. Because of its low cost, vinyl acetate is an attractive alternative to certain acrylate monomers, e.g., methyl methacrylate, for use in architectural coating latexes. Unfortunately, vinyl acetate-based copolymers suffer from poor hydrolytic stability, especially under alkaline conditions, and, accordingly, find only limited application in exterior coatings. Alkali resistance is extremely important, for example, when paints are applied over an alkaline construction material such as, for example, cement.

The availability of long-chain branched esters such as vinyl neo-nonanoate, vinyl neo-decanoate, vinyl neo-undecanoate, vinyl neo-dodecanoate, and the like, provides new choices of raw materials to increase the hydrophobic nature of the polymer. These monomers polymerize favorably with vinyl acetate as well as with acrylic monomers. This versatility provides the means of tailoring polymer properties to fit a variety of applications including interior and exterior paints, clear and pigmented wood coatings, corrosion resistant metal coatings and stable coatings and additives for cement and concrete. In addition, the broad range of Tg's available within the class of neo-monomers becomes very important in addressing the requirements of disparate coating applications with a common need for water resistance. One of the most useful features of branched vinyl esters is their resistance to hydrolysis, a valuable property for coatings on high pH substrates such as cement and cement composites. However, it is very difficult to copolymerize, and more so to homopolymerize, these monomers using known techniques, especially when they make up more than 50% of the polymer composition. Evidence of this difficulty is the fact that it is very difficult using known techniques to polymerize such monomers to make clean latexes, i.e., latexes which, when filtered over a 250-mesh screen for example, leave little or no residue on the screen. That, in turn, also points to the need for means to effectively and efficiently polymerize hydrophobic monomers.

Another disadvantage of using very hydrophobic monomers in emulsion polymerization is the very low water solubility of the monomers, which results in slow monomer transport and low reactivity.

Attempts to make homopolymers of very hydrophobic monomers, such as those of vinyl branched esters, have failed because of very low conversions even if the polymerization is conducted for a long time, e.g. in excess of 48 hours. There is also evidence of a curious inhibition, which is not well understood. (Balic, R., deBruyn, H., Gilbert, R. G., Miller, C. M. and Bassett, D. R., “Inhibition and Retardation in Emulsion Polymerization,” Proc. 74^{th} Colloid and Surf. Sci. Symp., Lehigh University, June, p. 19 (2000).

Many attempts to polymerize said monomers resort to costly techniques such as: use of organic solvents or other monomers to act as solvents for the hydrophobic monomer; use of macromolecular organic compounds having a hydrophobic cavity; and use of high levels of surfactants.

For example, U.S. Pat. No. 5,521,266 describes an aqueous polymerization method for forming polymers containing, as polymerized units, at least one monomer having low water solubility, including the steps of:
1) complexing at least one monomer having low water solubility with a macromolecular organic compound having a hydrophobic cavity; and
2) polymerizing in an aqueous system from about 0.1% to about 100%, by weight of the monomer component, based on the total weight of the polymer, of the complexed monomer having low water solubility with from about 0% to about 99.9% by weight, based on the total weight of the polymer, of at least one monomer having high water solubility.
   The macromolecular organic compounds with a hydrophobic cavity used in U.S. Pat. No. 5,521,266 include cyclodextrins and cyclodextrin derivatives.

U.S. Pat. No. 5,777,003 relates to redispersible polymer powder compositions, which comprise homo- or copolymers of ethylenically unsaturated monomers and cyclodextrins or cyclodextrin derivatives. Polymer dispersions are spray-dried and the resulting powders are formulated into mortar compositions. The flexural tensile strength and the adhesive strength of the mortars are enhanced in the presence of the cyclodextrin-containing dispersion powder, while the compressive strength is only slightly influenced.

Cyclodextrins and chemically modified cyclodextrins are very expensive compared to other components used in emulsion polymerization. In addition, cyclodextrins are water-soluble and their inclusion during the polymerization may impart undesirable properties to the polymer film such as reduced hydrophobicity. In addition, some monomers will be unable to diffuse or penetrate into the interior of the beads resulting in a reduced capacity and the need for larger amounts of cyclodextrins. This, in turn, results in undesirable attributes for the polymer films, brought about by the reduced hydrophobicity, which can be detrimental in coating applications.

The aforementioned methods use polar monomers to impart functionality to the latex particles. These polar monomers are usually carboxylic acids and hydroxy- and amide-containing monomers. It is well known to those skilled in the art that acid monomers are used in emulsion polymerization for various reasons, one being to improve latex stability. However, the presence of polymerized acid in the polymer is undesirable for coating applications and moisture sensitive applications, such as corrosion control, as it increases the affinity of the polymer for water, i.e., decreases the hydrophobicity of the polymer.

U.S. Pat. No. 5,686,518 discloses a polymerization process, referred to as miniemulsion polymerization, for polymerizing monomers and monomer mixtures which are said to be essentially insoluble in water, i.e., which have water solubility ranging from 0 to about 5 weight percent. The monomer or monomer mixture is emulsified to a very small droplet size, smaller than 0.5 microns, and is subsequently polymerized by conventional means. In order to achieve a miniemulsion, in addition to a surfactant, a polymeric co-surfactant is used at a level of 0.5 wt % to 5 wt % based on monomer. The co-surfactant accomplishes a reduction in monomer droplet size and as a result in latex particle size. Because the co-surfactant prevents monomer transfer from the small monomer droplets to the larger ones (i.e., Ostwald ripening), nucleation of the monomer droplets results in a final latex particle size similar to that of the monomer droplets.

U.S. Pat. No. 6,160,049 discloses an emulsion polymerization process that combines macroemulsion and miniemulsion feed streams for preparing an aqueous polymer dispersion from free-radically polymerizable compounds. The process requires feeding in separate streams a monomer with a solubility of at least 0.001 wt % and a monomer with a solubility of less than 0.001 wt %, and requires emulsification of both monomer streams. The emulsification of the monomer streams is done using high pressure homogenizers at pressures of up to 1200 bar. However, this peripheral equipment is not commonly found in conventional emulsion polymerization practice.

The polymerization of stearyl acrylate, a hydrophobic monomer, using methyl-beta-cyclodextrin as a phase transfer agent and dodecyl benzene sulfonate as a surfactant is described by Leyrer, R. J. and Machtle, W. in Macromol. Chem. Phys., 201, No. 12, 1235-1243 (2000). Stealyl acrylate is one of the hydrophobic monomers used in the examples of both U.S. Pat. Nos. 5,521,266 and 6,160,049.

In view of the disadvantages of known processes, a process is needed that is capable of polymerizing hydrophobic monomers to produce latexes, especially those that are useful for hydrophobic coatings. A process capable of covering the entire monomer solubility range from hydrophobic to extremely hydrophobic monomers in order to impart the maximum possible hydrophobicity to coatings would be desired.

### SUMMARY OF THE INVENTION

The process of the invention is such a desired process, and is a process comprising contacting a monomer composition, the monomer composition comprising at least one monomer having a water solubility of not more than about 0.02 g/100 g water, with at least one surfactant having a critical micelle concentration (CMC) of less than 0.05 wt %, the contacting taking place under emulsion polymerization conditions sufficient to polymerize the monomers of the monomer composition. Another embodiment of the invention is a novel alkene copolymer latex composition prepared from a reaction mixture comprising: (i) at least one alkene and at least one higher branched vinyl ester and optionally additional monomers; (ii) a surfactant with a critical micelle concentration of less than 0.05 wt %; and (iii) water. In yet another embodiment, the invention is a copolymer of at least two higher branched vinyl ester monomers.

Quite surprisingly, it has been found that use of very low CMC surfactants allows efficient polymerization of hydrophobic monomers.

### DETAILED DESCRIPTION OF INVENTION

The emulsion polymerization process of the present invention employs a surfactant having a CMC of less than about 0.05 weight percent and a hydrophobic monomer, and can be used to prepare the polymers of the invention. The process of the invention can be employed to prepare a homopolymer or a copolymer, i.e. a polymer formed from at least 2 monomers.

As used herein, the term “(meth)” as in (meth)acrylate, refers to the acrylate and/or the corresponding methacrylate, e.g. methyl (meth)acrylate refers to both methyl acrylate and methyl methacrylate. The term “copolymer” as used herein refers to a polymer polymerized from at least 2 monomers, and includes terpolymers, tetrapolymers, and the like.

As used herein, the term “polymerization conditions sufficient to polymerize the monomers of the monomer composition” means that the conditions are sufficient to achieve a monomer conversion of at least 90 percent. In different embodiments of the invention, the conversion is at least 95 percent, at least 98 percent, or at least 99 percent.

As used herein, the term “hydrophobic monomer” means any monomer with a water solubility of not more than about 0.02 g/100 g water, the term “very hydrophobic monomer” means any monomer with a water solubility of not more than about 0.01 g/100 g water and the term “extremely hydrophobic monomer” means any monomer with a water solubility of not more than about 0.001 g/100 g water. The water solubility values are measured at 20° C. using deonized water as the solvent. The solubility of some monomers in water is as follows, measured at 20° C. and expressed as g/100 g water: acrylonitrile, 7.1; methyl acrylate, 5.2; vinyl acetate, 2.5; ethyl acrylate, 1.8; methyl methacrylate, 1.5; ethylene, 1.1; vinyl chloride, 0.60; butyl acrylate, 0.16; styrene, 0.03; 2-ethylhexyl acrylate, 0.01; vinyl neo-pentanoate, 0.08; vinyl 2-ethylhexanoate, <0.01; vinyl neo-nonanoate, <0.001; vinyl neo-decanoate, <0.001; vinyl neo-undecanoate, <0.001; vinyl neo-dodecanoate, <0.001. These solubilities are from D. R. Bassett, “Hydophobic Coatings from Emulsion Polymers,” Journal of Coatings Technology, January 2001. Most of the neo-monomers exhibit much lower solubilities than the other monomers, with the exception of 2-ethylhexyl acrylate.

Shell developed a manufacturing process for making an isomeric mixture of highly branched tertiary monocarboxylic acids over thirty years ago. The C₉-C₁₁ acid mixture (versatic acid) is prepared via the Koch process which involves oligomerizing propylene in the presence of water and carbon monoxide to produce branched acids containing a neo structure on the carbon adjacent to the carbonyl carbon. The acid can then be converted into its vinyl ester by reaction with acetylene. The generic structure of branched vinyl esters is shown below:

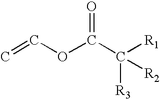

where R₁, R₂ and R₃ are alkyl groups. Preferably, R₁, R₂ and R₃ are independently C₁ -8 alkyl groups, and the total number of carbon atoms in R₁, R₂ and R₃ together is from 6 to about 10.

Essentially any monomer with a water solubility of not more than about 0.02 g/100 g water can be employed in the process of the invention. These monomers include, but are not limited to, vinyl esters of branched mono-carboxylic acids having a total of 8 to 12 carbon atoms in the acid residue moiety and 10 to 14 total carbon atoms such as, for example, vinyl 2-ethyl hexanoate, vinyl neo-nonanoate, vinyl neo-decanoate, vinyl neo-undecanoate, vinyl neo-dodecanoate and mixtures thereof (Shell Corporation sells vinyl neo-nonanoate, vinyl neo-decanoate and vinyl neo-undecanoate under the trade names, VeoVa 9, VeoVa 10 and VeoVa 11, respectively, while Exxon sells vinyl neo-dodecanoate and vinyl neo-decanoate under the trade names, Exxar 12 and Exxar 10, respectively). Higher vinyl esters are the preferred monomers in accordance with the present invention. As used herein, the term “higher vinyl ester” means a vinyl ester containing from about 8 to about 12 carbon atoms in the acid residue moiety. More preferably, the higher vinyl esters are branched vinyl esters. Preferred branched vinyl ester monomers are selected from the group consisting of vinyl pivalate, vinyl neo-nonanoate, vinyl 2-ethyl hexanoate, vinyl neo-decanoate, vinyl neo-undecanoate, vinyl neo-dodecanoate and mixtures thereof. Preferably, the monomer mixture employed in the invention comprises at least one higher branched vinyl ester.

Additional examples of hydrophobic monomers include vinyl 2-ethylhexanoate, vinyl laurate, vinyl stearate, vinyl alkyl or aryl ethers with (C₉-C₃₀) alkyl groups such as stearyl vinyl ether; (C₆-C₃₀) alkyl esters of (meth-)acrylic acid, such as hexyl (meth)acrylate, heptyl (meth)acrylate, octyl (meth)acrylate, isooctyl acrylate, isononyl acrylate, decyl (meth)acrylate, isodecyl (meth)acrylate, dodecyl (meth)acrylate, 2-ethylhexyl (meth)acrylate, benzyl (meth)acrylate, lauryl (meth)acrylate, oleyl (meth)acrylate, palmityl (meth)acrylate, and stearyl (meth)acrylate; unsaturated vinyl esters of (meth)acrylic acid such as those derived from fatty acids and fatty alcohols; monomers derived from cholesterol; olefinic monomers such as 1-butene, 2-butene, 1-pentene, 1 -hexene, 1 -octene, isobutylene and isoprene; and the like, provided, however, that any monomer that has a solubility of more than about 0.02 g/100 g water is not within the definition of hydrophobic. Mixtures of hydrophobic monomers can be employed.

If desired, a comonomer can be employed in the process of the invention. The additional monomers suitable for use in accordance with the present invention include any monomers which can impart the desired characteristics to the latex polymer compositions of the present invention. Examples of monomers that can be employed as the optional comonomer in the present invention include: styrene; substituted styrenes such as o-chlorostyrene and vinyl toluene; ethylene; propylene; 1,3-butadiene; lower vinyl esters i.e., those containing from 2 to about 4 carbon atoms in the acid residue moiety, such as vinyl acetate; vinyl chloride; vinylidine chloride; acrylonitrile; (meth)acrylamide; various C₁-C₄ alkyl or C₃-C₄ alkenyl esters of (meth)acrylic acid e.g. methyl methacrylate, methyl acrylate, ethyl (meth)acrylate, and butyl (meth)acrylate; ethylenically unsaturated dicarboxylic acid esters or derivatives thereof, such as diisopropyl fumarate, di-t-butyl funarate, and the dimethyl, dibutyl and diethyl esters of maleic acid or fumaric acid, or maleic anhydride; and sulfonic acids and salts thereof, such as vinyl sulfonic acid and the sodium or ammonium salts of ²-acrylamido-2-methylpropanesulfonic acid (AMPS® is a registered trademark of the Lubrizol Corporation). Mixtures of optional monomers can be employed. In one embodiment of the invention, the monomer composition is essentially free of vinyl acetate.

In a preferred embodiment of the invention, a higher branched vinyl ester is copolymerized with at least one monomer selected from the group consisting of: ethylene, propylene, 1-butene, 2-butene, 1-pentene, 1-hexene, isobutene, 1,3-butadiene, vinyl chloride, vinylidene chloride, or a mixture thereof.

The monomer mixture may contain from about 0.1 to about 100 percent of at least one hydrophobic monomer, based on the weight of monomers in the monomer mixture. The maximum amount of hydrophobic monomer polymerized into the polymer in various embodiments is at most about 50%, at most about 20%, at most about 10%, at most about 5%, or at most about 2%, based on the weight of monomer polymerized into the polymer, with the balance being the optional comonomer. The minimum amount of hydrophobic monomer polymerized into the polymer in various embodiments is at least about 0.1%, at least about 0.5%, at least about 1%, at least about 2%, or at least about 5%, based on the weight of monomer polymerized into the polymer, with the balance being the optional comonomer. In various embodiments of the invention, the monomer mixture may contain from about 0.1 to about 50 percent, from about 0.5 to about 20 percent, from about 1 to about 10 percent, or from about 2 to about 5 percent of at least one hydrophobic monomer, based on the weight of monomers in the monomer mixture.

In a preferred embodiment, a copolymer of the invention comprises from 0 to about 30, preferably from about 1 to about 25, weight percent of polymerized ethylene units, based on the weight of monomer polymerized into the polymer.

The monomer mixture may or may not contain a crosslinking monomer. Examples of crosslinking monomers include but are not limited to N-methylolacrylamide, N-methylolmethacrylamide, N-(allcoxymethyl)acrylamides or N-(alkoxymethyl)methacrylamides with a C₁-to C₆-allcyl radical, such as N-(isobutoxymethyl) acrylamide (IBMA), N-(isobutoxymethyl) methacrylamide (IBMMA), N-(n-butoxy-methyl)-acrylamide (NBMA) and N-(n-butoxy-methyl)-methacrylamide (NBMMA), polyethylenically unsaturated comonomers such as ethylene glycol diacrylate, 1,3-butylene glycol diacrylate, 1,4-butylene glycol diacrylate, propylene glycol diacrylate, divinyl adipate, divinyl benzene, vinyl methacrylate, allyl methacrylate, allyl acrylate, diallyl maleate, diallyl phthalate, diallyl fumarate, triallyl cyanurate and the like. Comonomer units which are suitable for modification of polymer adhesion properties include but are not limited to hydroxyalkyl esters of methacrylic acid and acrylic acid, such as hydroxyethyl, hydroxypropyl or hydroxybutyl acrylate or methacrylate, diacetone acrylamide, acetylacetoxyethyl acrylate or methacrylate and the like, allylic derivatives of aminoethylethylene urea, cyclic imides derivatives of ure/ureido monomers and the like.

Other examples of the crosslinking monomer include silanes such as vinyltrimethoxysilane, vinyl-tris-(2-methoxyethoxysilane), gamma-methacryloxypropyltrimethoxysilane, acryl or methacryl polyesters of polyhydroxylated compounds, divinyl esters of polycarboxylic acids, diallyl esters of polycarboxylic acids, diallyl terephthalate, N,N′-methylene diacrylamide, hexamethylene bis maleimide, triallyl phosphate, trivinyl trimellitate, glyceryl trimethacrylate, diallyl succinate, divinyl ether, the divinyl ethers of ethylene glycol or diethylene glycol, ethylene glycol diacrylate, polyethylene glycol diacrylates or methacrylates, n-methylol acrylamide, n-isobutoxymethyl acrylamide, trimethylol propane triacrylate, pentaerythritol triacrylate, hexanediol diacrylate, neopentyl glycol diacrylate, divinyl benzene, tri- or tetraethylene glycol diacrylate or methacrylate, the butylene glycol diacrylates or dimethacrylates, and the like. Mixtures of crosslinking monomer can be employed. Preferably, the amount of crosslinking agent is effective to provide a gel content of from 0% to 80%. As used herein, the term “gel content” means the part of a polymer that remains insoluble after its film has been allowed to dissolve in tetrahydrofuran (THF) for 4 days. The weight of this insoluble polymer expressed as a percent of the original dry film weight is referred to as the percent gel content of the polymer.

As used herein, the term “hydrophobic surfactant” means any surfactant with a critical micelle concentration of less than 0.05 wt %, the term “very hydrophobic surfactant” means any surfactant with a CMC less than 0.005 wt % and the term “extremely hydrophobic surfactant” means any surfactant with a CMC of less than 0.0009 wt %. For the purposes of the present invention, “CMC” means the surfactant concentration at which surfactant micelles start to form, and is measured by the Surface Tension-Surfactant Concentration Plot method as described in “Critical Micelle Concentrations of Aqueous Surfactant Systems,” United States Department of Commerce, National Bureau of Standards, NSRDS-NBS 36, Issued February 1971.

When surfactant is added to the monomer-water system, surfactant molecules dissolve in the aqueous phase. These surfactant molecules, in turn, transfer to the liquid air interface as well as to the monomer-water interface. Further addition of surfactant results in the saturation of the air-liquid surface and the monomer-water interface. Increasing the surfactant concentration to a level equal to the CMC results in micelle formation. Any excess surfactant in the aqueous phase will be in equilibrium with surfactant adsorbed at the liquid/air and monomer-water interfaces and the micelles. Above the CMC any increase in the amount of surfactant will only lead to a higher number of micelles. In accordance with the present invention, the surfactant employed suitably has a CMC value of less than about 0.05 wt %, more preferably less than 0.005 wt % and most preferably less than about 0.0009 wt %. The role of the hydrophilic part of the surfactant, whether nonionic, zwitter-ionic, or ionic (with associated counterions), is essential for conferring enough solubility to the hydrocarbon chain so that CMC values can be reached or exceeded, but with that condition satisfied it is not critical to the present invention whether the surfactant is nonionic, zwitter-ionic, or ionic.

Numerous anionic, non-ionic, cationic and amphoteric surfactants with CMC values useful in the present invention are described in the literature, such as McCutcheon's Detergents and Emulsifier 1998, North America Edition, MC Publishing Company, Glen Rock, N.J. The critical micelle concentration of many surfactants can be found in “Critical Micelle Concentrations of Aqueous Surfactant Systems,” United States Department of Commerce, National Bureau of Standards, NSRDS-NBS 36, Issued February 1971. A list of CMC values for some surfactants can be found in Rosen, M. J., “Surfactants and Interfacial Phenomena,” Second Ed., John Wiley & Sons, New York, 1989, Table 3-2, page 122).

In a preferred embodiment of the present invention, the surfactant employed is selected on the basis that its solubility, as reflected by the CMC, is similar to the solubility of the monomer or monomer mixture that is to be polymerized. Accordingly, in a preferred embodiment of the invention, any combination of low-CMC surfactant and hydrophobic monomer can be used as long as the solubility of the two in the polymerizing medium is similar to each other. In other words, it is preferred that the more hydrophobic the monomer the more hydrophobic, and hence the lower the CMC of, the surfactant to be used in the polymerization according to the present invention.

The particular surfactant system useful for conducting the polymerization reaction is not critical to the present invention as long as the CMC of at least one of the surfactants present is in the 0.00001 wt % to 0.05 wt % range, and as long as the surfactant system supports emulsion polymerization. Polymerizable and/or reactive surfactants can be employed. Examples of surfactants that can suitably be employed in the present invention include anionic surfactants such as diester sulfosuccinates, monoester sulfosuccinates, sulfosuccinamates, nonyl phenol ether sulfates and sodium salts of alkyl aryl polyether sulfonates, fatty alcohol ether sulfates, alkyl phenol ether sulfates, and low CMC phosphate surfactants such as aliphatic phosphate esters with 3, 6 and 10 moles ethylene oxide. Examples of suitable nonionic surfactants include alkyl aryl polyether alcohols, alkyl phenol ethoxylates, fatty alcohol ethoxylates and fatty acid esters. Examples of commercially available surfactants include Aerosol® TR-70, Aerosol® TR-70-HG, Aerosol® 501, Aerosol® OT-85AE, Aerosol® OT-NV, Aerosol® A-103, Aerosol® 18, Aerosol®22, Aerosol® NPES-428, Aerosol® NPES-430, Aerosol® NPES-458, Aerosol® NPES-930, Aerosol® NPES-2030, Aerosol® NPES-3030, Aerosol® DPOS-45, Rhodapex® CO-433, Rhodafac® RS-410, Rhodafac® RS-610, Rhodafac® RS-710, Igepal® CA-630, Igepal® CO-630, Igepal® CO-710, Igepal® CO-720, Igepal® CO-730, Rhodosurf® L-790, ATPOL E-1231, ATPOL E-1501, ATPOL E-1502, Calsolene Oil HS, ATPOL E-5730, ATPOL E-5837, BRIJ 35 and BRIJ 58. Aerosol® surfactants are marketed by CYTEC Industries, Inc. of West Paterson, N.J. Igepal®, Rhodapex®, Rhodafac® and Rhodosurf® surfactants are marketed by Rhodia, Inc., Cranbury, N.J. ATPOL, Calsolene Oil HS, and BRIJ surfactants are marketed by Uniqema, an international business of Imperial Chemical Industries PLC. Mixtures of surfactants can be employed, including mixtures of low-CMC and non-low-CMC surfactants.

Polymerizable surfactants, often referred to in the art as reactive surfactants, are useful in polymerizing monomers and monomer mixtures according to the present invention. Polymerizable surfactants have all the typical properties of conventional surfactants such as micelle formation and interfacial tension reduction; indeed, because of their long hydrophobes they also tend to possess low CMC values. In addition, polymerizable surfactants contain a polymerizable group and therefore are incorporated in the polymer chains that make up the latex particles. As a result of their incorporation in the polymer chain, polymerizable surfactants, as opposed to conventional surfactants, do not migrate to the surface of the film or the substrate/polymer interface, eliminating the problems associated with surfactant migration, such as adhesion loss, water spotting, and blushing.

The reactive surfactant useful in the present invention suitably is a compound with at least one ethylenically unsaturated double bond for free radical polymerization with the monomers and monomer mixtures while also containing hydrophobic and hydrophilic moieties similar to conventional surfactants in order to maintain surface activity. Surfactant monomers including long chain alkoxy- or alkylphenoxy-polyalkylene oxide (meth) acrylates, such as C₁₈H₂₇-(ethylene oxide)₂₀ methacrylate and C₁₂H₂₅-(ethylene oxide)₂₃ methacrylate and the like; and the reactive surfactants disclosed in U.S. Pat. No. 4,075,411, the teachings of which are incorporated herein by reference, and which are the esters of acrylic, methacrylic and crotonic acids and the mono-and di-esters of maleic, fumaric, itaconic and aconitic acids with (a) C₈-C₂₀ allcylphenoxy (ethyleneoxy)₁₀₋₆₀ ethyl alcohol, (b) (ethyleneoxy)₁₅₋₂₅ sorbitan esters of C₁₂-C₂₀ fatty acids and (c) methyl cellulose, hydroxymethyl cellulose, hydroxyethyl cellulose and polyvinyl alcohol. Reactive surfactants include those comprised of ring sulfonated half esters of maleic anhydride with alkoxylated alkyl arylols, such as those disclosed in U.S. Pat. No. 4,224,455, the teachings of which are incorporated herein by reference.

Other non-ionic surfactants that preferably are employed by the present invention include the Tetronic®, Tetronic® R, Pluronic® and Pluronic® R series of ethylene oxide-propylene oxide block copolymer surfactants marketed by BASF Corporation.

Pluronic® surfactants do not micellize at a CMC but instead aggregation takes place over a broad concentration range which is referred to as the aggregation concentration range (ACR) (BASF Performance Chemicals—“Pluronic® and Tetronic® Surfactants Product Description Catalog,” ©BASF Corporation, 1996). Said Catalog defines the limiting aggregation concentration (LAC) as the concentration at which the surfactant reaches saturation, which, as stated in said Catalog, “would correspond to the more conventional critical micelle concentration.” For the purposes of the present invention, the lower limit of the aggregation concentration range is a characteristic concentration above which solubilization of the hydrophobic monomers is enhanced and, when applicable, is used as the CMC for the purposes of this invention.

TABLE 1
Aggregation Concentrations of Pluronic Surfactants

| | Aggregation | |
|---|---|---|
| Pluronic ® | Concentration | |
| Surfactant | Range (ppm) ¹ | CMC (wt. %) |
| L 35 | 2,000-100,000 | 0.2 |
| P65 | 200-50,000 | 0.02 |
| P75 | 1,000-50,000 | 0.1 |
| P85 | 500-50,000 | 0.05 |
| P103 | 50-1,000 | 0.005 |
| P104 | 100-1,500 | 0.01 |
| P105 | 50-2,000 | 0.005 |
| F-108 | 400-50,000 | 0.04 |

¹ BASF Performance Chemicals - Pluronic ® and Tetronic ® Surfactants Product Description Catalog, ©BASF Corporation, 1996
Pluronic ®, Pluronic ® R, Tetronic ® and Tetronic ® R surfactants suitable for use in the present invention include Pluronic ® L-61, Pluronic ® L-101, Pluronic ® P-103, Pluronic ® P-104, Pluronic ® P-105, Pluronic ® L-121, Pluronic ® F-127, Pluronic ® 31R1, Pluronic ® 25R1, Tetronic ® 701, Tetronic ® 901, Tetronic ® 1101, Tetronic ® 1301, Tetronic ® 1501, Tetronic ® 150R1, Tetronic ® 130R1, Tetronic ® 110R1, Tetronic ® 50R1, Tetronic ® 70R1, Tetronic ® 90R1.

The amount of hydrophobic surfactant employed suitably is an amount that is effective to enhance polymerization of a monomer mixture containing a hydrophobic monomer under emulsion polymerization conditions. The amount of the hydrophobic surfactant in the polymerization mixture is preferably from 0.01 wt % to 5 wt % based on monomer, more preferably from 0.05 wt % to 3 wt % active based on monomer and most preferably from 0.1 to 1.5 wt % based on monomer. The amount of other surfactants, in addition to the extremely hydrophobic surfactant that may be present during the polymerization of the monomers of the present invention, is suitably from 0 wt % to 5 wt % based on monomer, preferably from 0 wt % to 3 wt % based on monomer and more preferably from 0 to 1.5 wt % based on monomer. These hydrophobic surfactant weight percentages are based on the weight of the dry surfactant, i.e. the surfactant in the absence of water.

The latex polymers of the present invention are typically in colloidal form, i.e., aqueous dispersions, and preferably are prepared by emulsion polymerization in the presence of an initiator and, optionally, a chain transfer agent.

In carrying out the emulsion polymerization, an initiator (also referred to in the art as a catalyst) is preferably employed at a concentration sufficient to initiate the polymerization reaction. The amount of initiator suitably is from about 0.01 to about 3 weight percent, preferably is from about 0.05 to 2 weight percent, and most preferably is from about 0.1 to about 1 weight percent, based on the weight of the monomers charged. The particular concentration employed will depend upon the specific monomer mixture undergoing reaction and the specific initiator employed, as is well known to those skilled in the art. Illustrative initiators include hydrogen peroxide, peracetic acid, t-butyl hydroperoxide, di-t-butyl hydroperoxide, dibenzoyl peroxide, benzoyl hydroperoxide, 2,4-dicholorbenzoyl peroxide, 2,5-dimethyl-2,5-bis(hydroperoxy) hexane, perbenzoic acid, t-butyl peroxypivalate, t-butyl peracetate, dilauroyl peroxide, dicapryloyl peroxide, distearoyl peroxide, dibenzoyl peroxide, diisopropyl peroxydicarbonate, didecyl peroxydicarbonate, dicicosyl peroxydicarbonate, di-t-butyl perbenzoate, 2,2′-azobis-2,4-dimethylvaleronitrile, ammonium persulfate, potassium persulfate, sodium persulfate, sodium perphosphate, and azobisisobutyronitrile, as well as any of the other known initiators. Also useful are redox initiator systems such as sodium persulfate-sodium formaldehyde sulfoxylate, cumene hydroperoxide-sodium metabisulfite, hydrogen peroxide-ascorbic acid, and other known redox systems. Moreover, as known by those skilled in the art, traces of certain metal ions can be added as activators to improve the rate of polymerization, if desired.

When employed, a chain transfer agent is suitably present during the polymerization reaction at a concentration of from about 0.01 to about 5 weight percent, preferably from about 0.1 to about 1 weight percent, based on the total monomer content. Both water-insoluble and water-soluble chain transfer agents can be employed. Examples of substantially water-soluble chain transfer agents include alkyl and aryl mercaptans such as butyl mercaptan, isooctyl-3-mercaptopropionate, mercaptoacetic acid, mercaptoethanol, 3-mercaptol-1,2-propanediol and 2-methyl-2-propanethiol. Examples of substantially water-insoluble chain transfer agents include, for example, t-dodecyl mercaptan, phenyl mercaptan, pentaerythritol tetramercaptopropionate, octyldecyl mercaptan, tetradecyl mercaptan and 2-ethylhexyl-3-mercaptopropionate.

The apparatus utilized to conduct the polymerization is not critical to the present invention and includes reactors such as, for example, continuous stirred tank reactors, plug flow reactors, wet bed fluidized reactors and loop reactors. The details of suitable apparatus are known to those skilled in the art. The process employed for preparing the compositions of the present invention is not critical and may be batch, semi-continuous or continuous. The process of the present invention can also be carried out by introducing a pre-made latex to the reactor, before and/or during the polymerization of the monomers of the present invention, which will become the inner core of the final latex particle. In addition, all or some of the monomer streams can be mixed and/or be emulsified in a monomer tank prior to entering the polymerization zone or can be added individually to the reactor. Specific details concerning procedures and conditions for emulsion polymerization are known to those skilled in the art, and any convenient temperature and pressure can be used. Preferably, the polymerization is conducted at a temperature of from about 25 to 90° C. When ethylene is employed as a comonomer, the pressure in the reactor for at least a portion of the reaction is advantageously from about 50 to about 1,200 psig or higher, more preferably from about 60 to about 500 psig, and most preferably from about 75 to about 300 psig.

The process of the present invention can also be carried out by feeding separate and distinct monomer mixtures to the reaction mixture during the polymerization (known in the art as “staged feed”) or by varying the rates of monomer addition during the polymerization (known in the art as “power feed”). This type of operation can be conveniently conducted by providing a monomer holding zone containing the second monomer and then introducing the first monomer to the holding zone while withdrawing a stream from the holding zone which comprises the first monomer and the second monomer. In this process mode, the first monomer can be the hydrophobic monomer and the second monomer can be the rest of the monomers involved in the polymerization. In this process mode, “second” monomer and “first” monomer refer to any of the monomers to be polymerized, the choice being one of convenience. Further details concerning this type of operation are disclosed, for example, in U.S. Pat. Nos. 3,804,881 and 4,039,500, the teaching of which are incorporated herein by reference. In another aspect of the invention, the monomers can be fed to the reactor after they are first emulsified prior to entering the reaction zone. Reduction of residual monomer levels can be accomplished according to methods well known in the art. The above described aspects of the present invention may be conducted in combination with each other or independently.

The glass transition temperature of the polymer of the present invention is typically in the range of −80 to 90° C., preferably −70 to 30° C., and can be achieved by the appropriate combination of the comonomers involved in the copolymerization as known to those skilled in the art. The Tg of the polymer of the present invention used in paint applications is typically from about −15 to 20° C., preferably from about −10 to 10° C. and more preferably from about 0 to 5° C. When the polymer of the present invention is used in pressure sensitive adhesive (“PSA”) applications, the Tg of the polymer is typically from −60 to −5° C., preferably from about −45 to −15° C. and more preferably from about −40 to −30° C. As used herein, the term “Tg” means glass transition temperature. Techniques for measuring the glass transition temperature of polymers are known to those skilled in the art. One such technique is, for example, differential scanning calorimetry. A particularly useful means of estimating the glass transition temperature of a polymer is that given by the Fox equation:

1/Tg_{(polymer)}=x₁/Tg₁+x₂/Tg₂+x₃/Tg₃+ . . . +xₙ/Tgₙ

where x₁ is the weight fraction of the first monomer in the copolymer and Tg₁ is the homopolymer glass transition temperature of the first monomer. For the preferred monomers and comonomers of this invention, these homopolymer glass transition temperatures are: vinyl acetate=32° C., butyl acrylate=−54° C., 2-ethylhexyl acrylate=−70° C., vinyl neo-decanoate=−3° C., vinyl neo-nonanoate=60° C., vinyl neo-pentanoate=86° C., vinyl 2-ethylhexanoate=−50° C., vinyl propionate=10° C.

The reaction products comprising the latex polymers of the present invention typically have a solids content of from about 10 to 90 weight percent, preferably from about 45 to 75 weight percent, and more preferably from about 50 to 70 weight percent based on the weight of the latex. The volume average particle size of the latex polymer is from about 0.03 to 2.0 microns, preferably from about 0.1 to 1.0 microns, more preferably from about 0.3 to 0.5 microns, and more preferably from about 0.15 to 0.30 microns. The copolymers of the invention preferably are random copolymers. Examples of copolymers of the present invention include, for example: copolymers of at least two higher branched vinyl ester monomers, such as poly(vinyl neo-undecanoate-co-vinyl neo-decanoate) copolymers, poly(vinyl neo-nonanoate-co-vinyl neo-decanoate) copolymers and poly(vinyl neo-nonanoate-co-vinyl neo-decanoate-co-vinyl undecanoate) terpolymers. A preferred class of copolymers of the invention are copolymers that comprise in polymerized form a polymerization mixture comprising a higher branched vinyl ester, such as, for example, copolymers wherein the polymerization mixture comprises at least two monomers selected from the group consisting of vinyl neo-nonanoate, vinyl neo-decanoate, vinyl neo-undecanoate, and vinyl neo-dodecanoate. Another preferred class of copolymers of the invention are copolymers that comprise in polymerized form a polymerization mixture comprising ethylene and at least one, preferably at least two, higher branched vinyl ester(s), such as, for example, copolymers wherein the polymerization mixture comprises ethylene and at least one monomer selected from the group consisting of vinyl neo-nonanoate, vinyl neo-decanoate, vinyl neo-undecanoate, and vinyl neo-dodecanoate. Examples of such copolymers include poly(ethylene-co-vinyl neo-nonanoate-co-vinyl neo-undecanoate) terpolymers, poly(ethylene-co-vinyl neo-nonanoate-co-vinyl neo-decanoate) terpolymers, poly(ethylene-co-vinyl neo-nonanoate-co-vinyl neo-dodecanoate) terpolymer, poly(ethylene-co-vinyl neo-decanoate-co-vinyl neo-undecanoate) terpolymer, poly(ethylene-co-vinyl neo-decanoate-co-vinyl neo-dodecanoate) terpolymer, and poly(ethylene-co-vinyl neo-undecanoate-co-vinyl neo-dodecanoate) terpolymer.

The polymers made according to the present invention are useful in any application where hydrophobicity in a latex is desired. The latex compositions of the present invention can have a variety of end uses including for example: as protective or decorative coatings, e.g., latex paints; adhesives, e.g., PSA's; personal care applications, e.g., hair fixatives; and industrial coatings. Other potential applications include, for example, films, caulks and sealants, mastics, inks, paper coatings, masonry additives, leather applications, nonwovens, textiles, additives to improve the flow of crude oil and middle distillates, corrosion-resistant primer coatings for metals, adhesives for hard-to-adhere surfaces, such as plastics, e.g., polypropylene and polyvinyl chloride, and water-proofing coatings for concrete, wood, tile, brick and metal.

The following examples are provided for illustrative purposes and are not intended to limit the scope of the claims. Weights are given in grams and percentages are given in weight percent unless otherwise stated. All amounts refer to the materials as such, i.e., without adjustment for their solids content.

### SPECIFIC EMBODIMENTS OF THE INVENTION

The following ingredients are used in the Examples that follow.

| Ingredient | Description |
|---|---|
| Nalco 2343 | defoamer, available from Nalco Chemical, Naperville, IL |
| Rhodacal DS-4 | sodium dodecyl benzene sulfonate, available from Rhodia, Inc., |
| | Cranbury, NJ |
| Aerosol MA-80-I | sodium dihexyl sulfosuccinate, available from Cytec Industries, |
| | West Paterson, NJ |
| Aerosol TR-70 or | sodium bis-tridecyl sulfosuccinate, available from Cytec Industries, |
| Aerosol TR-70-HG | West Paterson, NJ |
| Aerosol A-102 | disodium ethoxylated alcohol half ester of sulfosuccinic acid, |
| | available from Cytec Industries, West Paterson, NJ |
| Pluronic L-61 | ethylene oxide-propylene oxide copolymers having an average |
| | molecular weight of 2,000 g/gmole, available from BASF |
| | Performance Chemicals, Mount Olive, NJ |
| Pluronic L-64 | ethylene oxide-propylene oxide copolymers having an average |
| | molecular weight of 2,900 g/gmole, available from BASF |
| | Performance Chemicals, Mount Olive, NJ |
| Cellosize QP-300 | hydroxyethyl cellulose having a molecular weight of about |
| | 300,000 g/gmole, available from Union Carbide Corporation, |
| | Danbury, CT |

### Latex Preparation Method 1

The monomer mixture is prepared by charging the appropriate amount of monomer(s) and surfactants to a vessel and mixing the contents using a variable speed agitator. The initial charge is added to a 1-gallon glass reactor equipped with an agitator. The temperature desired for the polymerization is achieved by adjusting the temperature set point of a thermostated water bath. The reactor's agitator speed is set to 200 rpm, and the initial monomer charge is added to the reactor. Once the addition of the initial monomer is completed, the initial initiator charge is added to the reactor followed by the initial reducer charge. The reactor temperature increases as a result of the exotherm due to the polymerization of the initial charge. After the exotherm, the reactor contents are allowed to react further in the absence of any additional monomer for 2 minutes. Then the delayed monomer, the fed catalyst and the fed reducer feeds all are started at the same time. When all the feeds are finished, the reactor contents are allowed to further react (post-heat) for from 30 to 70 minutes in order to facilitate residual monomer reduction. After this post-heat step, the post-catalysis step is started. Post-oxidizer and post reducer solutions are fed over a period of time in order to ensure that residual monomer levels are within desired limits. After the post-catalysis is complete, the reactor is cooled to below 30° C.

### EXAMPLE 1

A vinyl neo-decanoate homopolymer latex is prepared using Latex Preparation Method 1 and the conditions and formulation given in Table 2. This example illustrates the use of Aerosol TR-70, an anionic surfactant; the CMC of which is listed by the manufacturer as being from 0.0005 to 0.001 wt %. In addition, Rhodacal DS-4 and Aerosol A-102, both anionic surfactants with CMC values, as listed by the manufacturers, of about 0.1 wt %, are used.

TABLE 2
Summary of Formulations and Polymerization Conditions

| | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Ingredient | grams | grams | grams | grams | grams | grams | grams | grams | grams | grams |
| Monomer Mix | | | | | | | | | | |
| Vinyl neo-decanoate | 714 | 714 | 714 | 714 | 357.0 | 357.0 | 349.9 | 142.8 | 3614 | 1428 |
| Vinyl neo-nonanoate | | | | | 357.0 | 357.0 | 349.9 | | 3614 | |
| Nalco 2343 | 3.40 | 3.40 | 3.40 | 3.40 | 3.40 | 3.40 | 3.40 | 3.40 | 34.4 | 34 |
| Aerosol TR-70 | 9.0 | 9.0 | 9.0 | 13.0 | 13.0 | 13.0 | 6 | | 131.6 | |
| Methacrylic acid | | | | | | | 7.14 | | | |
| 2-hydroxyethyl | | | | | | | 7.14 | | | |
| acrylate | | | | | | | | | | |
| vinyl acetate | | | | | | | | 571.2 | | 5712 |
| Pluronic L-61 | | | | | | | | 19.71 | | 197.1 |
| Ethylene | | | | | | | | | Add to | see text of |
| | | | | | | | | | 250 psig | Ex. 10 |
| Initial Monomer | varies | varies | 55.7 | 55.7 | 55.7 | 55.7 | 55.7 | 55.7 | varies | varies |
| charge | | | | | | | | | | |
| Initial Charge | | | | | | | | | | |
| D.I. Water | 470.0 | 470.0 | 470.0 | 470.0 | 470.0 | 470.0 | 470.0 | 470.0 | 4757.5 | 4700 |
| Sodium Acetate | 1.44 | 1.44 | 1.44 | 1.44 | 1.44 | 1.44 | 1.44 | 1.44 | 14.60 | 14.35 |
| Rhodacal DS-4 | 1.68 | 1.68 | | | | | | 15.62 | | 156.22 |
| Nalco 2343 | 0.68 | 0.68 | 0.68 | 0.68 | 0.68 | 0.68 | 0.68 | 0.68 | 6.90 | 6.76 |
| Aerosol MA-80-I | | | 2.50 | 2.50 | 4.70 | 4.70 | 4.70 | | 67.60 | |
| Water Rinse | 28.0 | 28.0 | 28.0 | 28.0 | 28.0 | 28.0 | 28.0 | 28.0 | 283.0 | 280.0 |
| Cellosize QP-300 | | | | | | | | 3.75 | | 37.49 |
| Pluronic L-64 | | | | | | | | 12.85 | | 130.50 |
| Ferrous Sulfate (in 50 g | | | | | | | | | | 0.07 |
| water) | | | | | | | | | | |
| Initial Oxidizer | | | | | | | | | | |
| deionized water | 10.0 | 10.0 | 10.0 | 10.0 | 10.0 | 10.0 | 10.0 | 10.0 | | |
| t-butyl hydroperoxide | 0.44 | 0.88 | 0.8 | 0.8 | 0.90 | 0.90 | 0.90 | 0.30 | | |
| (70 percent active) | | | | | | | | | | |
| Initial Catalyst | | | | | | | | | | |
| deionized water | | | | | | | | | 101.2 | 50.0 |
| t-butyl hydroperoxide | | | | | | | | | 27.3 | |
| (70 percent active) | | | | | | | | | | |
| Ammonium | | | | | | | | | | 3.04 |
| Persulfate | | | | | | | | | | |
| Initial Reducer | | | | | | | | | | |
| deionized water | 7.5 | 7.5 | 7.5 | 7.5 | 7.5 | 7.5 | 7.5 | 7.5 | 75.9 | 75.0 |
| sodium formaldehyde | 0.32 | 0.64 | 0.64 | 0.64 | 0.74 | 0.74 | 0.74 | | 22.5 | |
| sulfoxylate, solid | | | | | | | | | | |
| Sodium Metabisulfite | | | | | | | | 0.32 | | 3.17 |
| Exotherm | | | | | | | | | | |
| From: (° C.) | 71 | 71 | 71 | 71 | 76 | 76 | 74 | 72 | 77.1 | 73.2 |
| to: (° C.) | 73-74 | 73-74 | 73-74 | 73-74 | 79-80 | 79-80 | 77-78 | 77-78 | 79 | 77.5 |
| Fed Catalyst | | | | | | | | | | |
| deionized water | | | | | | | | 7.5 | 703.5 | 820.0 |
| t-butyl hydroperoxide | | | | | | | | | 28.3 | |
| (70 percent active) | | | | | | | | | | |
| Aerosol A-102 | | | | | | | | | 121.5 | |
| Ammonium | | | | | | | | 0.32 | | 8.56 |
| persulfate | | | | | | | | | | |
| Fed | | | | | | | | | | |
| Oxidizer/Surfactant | | | | | | | | | | |
| deionized water | 69.6 | 69.6 | 69.6 | 69.6 | 70.9 | 70.9 | 69.9 | | | |
| t-butyl hydroperoxide | 1.30 | 1.30 | 1.30 | 1.30 | 1.4 | 1.4 | 1.4 | | | |
| (70 percent active) | | | | | | | | | | |

| | | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|
| Aerosol A-102 | 20.0 | 25 | 20.0 | 20.0 | 11.0 | 13.0 | 12.0 | | | |
| Fed Reducer | | | | | | | | | | |
| deionized water | 82.5 | 82.5 | 82.5 | 82.5 | 82.5 | 82.5 | 82.5 | 82.5 | 828 | 825 |
| sodium formaldehyde | 0.74 | 0.74 | 0.74 | 0.74 | 0.84 | 0.84 | 0.84 | | | |
| sulfoxylate, solid | | | | | | | | | | |
| Sodium metabisulfite | | | | | | | | 0.43 | | 4.28 |
| Sodium | | | | | | | | | 17.9 | |
| formaldehyde | | | | | | | | | | |
| sulfoxylate, solid | | | | | | | | | | |
| Post Heat (° C.) | 70 | 70 | 70 | 70 | 76-78 | 76-78 | 76-78 | 70 | 76-78 | 70-80 |
| Post Heat (Minutes) | 60 | 70 | 60 | 60 | 60 | 60 | 60 | 33 | 60 | 30 |
| Post-Catalyst- | | | | | | | | | | |
| Oxidizer | | | | | | | | | | |
| deionized water | 27.2 | 27.2 | 27.2 | 27.2 | 27.2 | 27.2 | 27.2 | 27.2 | 275.3 | 146 |
| t-butyl hydroperoxide | 1.30 | 1.30 | 1.30 | 1.30 | 1.30e | 1.30 | 1.30 | 1.30 | 26.4 | 4.0 |
| (70%) | | | | | | | | | | |
| Feed Time | 25 | 30 | 30 | 30 | 64 | 64 | 60 | 60 | 120 | 45 |
| Post-Catalyst-Reducer | | | | | | | | | | |
| deionized water | | | | | | | | | 275.3 | |
| Sodium Metabisulfite | | | | | | | | | 15.0 | |
| Feed Time | | | | | | | | | 120 | |
| Post-Catalyst-Reducer | | | | | | | | | | |
| deionized water | 27.2 | 27.2 | 27.2 | 27.2 | 27.2 | 27.2 | 27.2 | 27.2 | | 147 |
| Sodium formaldehyde | 0.74 | 0.74 | 0.74 | 0.74 | 0.74 | 0.74 | 0.74 | 0.74 | | 3.0 |
| sulfoxylate, solid | | | | | | | | | | |
| Feed Time | 25 | 30 | 30 | 30 | 64 | 64 | 60 | 60 | | 45 |
| Polymerization Temp. | 72 | 72 | 72 | 72 | 78 | 78 | 78 | 72 | 78 | 72 |
| (° C.) | | | | | | | | | | |
| Feed Time (hours) | 3 | 3 | 3 | 3 | 3 | 3 | 3 | 3 | 3 | 3 |

At the end of post-catalysis, the residual vinyl neo-decanoate monomer level is 6,144 ppm and a second post-catalysis is done to bring the residual vinyl neo-decanoate monomer level to less than 2,500 ppm, and the product is recovered. Table 3 lists typical properties of the poly(vinyl neo-decanoate) homopolymers made by the process described above.

### EXAMPLE 2

The procedure of Example 1 is repeated, except that the amount of Aerosol A-102 is increased to 25 grams and twice the amounts of the initial oxidizer and initial reducer are used. At the end of post-catalysis the residual vinyl neo-decanoate monomer level is 2,076 ppm. The properties of the latex obtained are listed in Table 3.

TABLE 3
Physical Properties of Poly(vinyl neo-decanoate) Homopolymer Latex

| | | | | Brookfield | Filterables | |
|---|---|---|---|---|---|---|
| | Tot. | | Particle | Viscosity | (40/200 | |
| | Solids, | | Size | (LVT, #3, | mesh) | Agitator |
| Latex | (%) | pH | (micron) | 60 rpm) | (ppm) | Scrap, (g) |
| Example 1 | 51.6 | 5.0 | 0.222 | 80 | 568/167 | 0.68 |
| Example 2 | 52.0 | 5.0 | 0.231 | 80 | 584/486 | 0.83 |

Note that for all experimental determinations of particle size and particle size distribution, the instrument employed is a Leeds & Northrup Microtrac UPA (Ultrafine Particle Size Analyzer), which is designed to measure particle size distribution in the range of 0.0032 microns to 6.54 microns via the dynamic light scattering technique.

### EXAMPLE 3

A vinyl neo-decanoate homopolymer latex is prepared according to the formulation and procedure given in Table 2 using Latex Preparation Method 1. This example illustrates the use of Aerosol TR-70 and Aerosol A-102. In addition, Aerosol MA-80-I with a high CMC of about 1.3 wt %, as listed by the manufacturer, is employed.

At the end of post-catalysis, the residual vinyl neo-decanoate monomer level is 1014 ppm. The product is recovered after the post-catalysis stage is complete. Table 4 lists properties of the resulting poly(vinyl neo-decanoate) homopolymers.

### EXAMPLE 4

A vinyl neo-decanoate homopolymer latex is prepared using the procedure of Example 3, except that the amount of Aerosol TR-70 is increased to 13 grams. At the end of post-catalysis, the residual vinyl neo-decanoate monomer level is 1195 ppm. The properties of the resulting latex are given in Table 4.

TABLE 4
Physical Properties of Poly(vinyl neo-decanoate) Homopolymer Latex

| | | | | Brookfield | Filterables | |
|---|---|---|---|---|---|---|
| | Tot. | | Particle | Viscosity | (40/200 | |
| | Solids, | | Size | (LVT, #3, | mesh) | Agitator |
| Latex | (%) | pH | (micron) | 60 rpm) | (ppm) | Scrap, (g) |
| Example 3 | 51.9 | 4.8 | 0.347 | 60 | 50/313 | 0.23 |
| Example 4 | 52.0 | 4.8 | 0.416 | 50 | 24/144 | 0.13 |

### EXAMPLE 5

A latex comprising a copolymer of vinyl neo-nonanoate and vinyl neo-decanoate is prepared according to the formulation and procedure given in Table 2 using Latex Preparation Method 1. This example illustrates the use of Aerosol TR-70 to polymerize a mixture of vinyl neo-nonanoate and vinyl neo-decanoate, two extremely hydrophobic monomers. In addition, Aerosol MA-80-I and Aerosol A-102 are employed.

At the end of post-catalysis, the residual vinyl neo-nonanoate and vinyl neo-decanoate monomer levels are 638 ppm and 1,026 ppm, respectively. The physical properties of the latexes are listed in Table 5.

### EXAMPLE 6

The method of Example 5 is repeated, except that the amount of Aerosol A-102 is 13 grams. At the end of post-catalysis the residual vinyl neo-nonanoate and vinyl neo-decanoate monomer levels are 906 ppm and 898 ppm, respectively. The properties of the latex obtained are listed in Table 5.

### EXAMPLE 7

A latex comprising a copolymer of vinyl neo-nonanoate and vinyl neo-decanoate, 1 wt %, based on monomer, methacrylic acid and 1 wt %, based on monomer, of hydroxyethyl acrylate is prepared according to the formulation and procedure given in Table 4 using Latex Preparation Method 1. This example illustrates the use of Aerosol TR-70. In addition, Aerosol MA-80-I and Aerosol A-102 are employed.

At the end of post-catalysis the residual vinyl neo-nonanoate and vinyl neo-decanoate monomer levels are 950 ppm and 2,330 ppm, respectively. The properties of the resulting latex are given in Table 5.

TABLE 5
Physical Properties of Poly(vinyl neo-nonanoate/vinyl neo-decanoate:
50/50) Copolymers

| | | | | Brookfield | Filterables | |
|---|---|---|---|---|---|---|
| | Tot. | | Particle | Viscosity | (40/200 | |
| | Solids, | | Size | (LVT, #3, | mesh) | Agitator |
| Latex | (%) | pH | (micron) | 60 rpm) | (ppm) | Scrap, (g) |
| Example 5 | 51.5 | 4.6 | 0.596 | 40 | 5/24 | 0.47 |
| Example 6 | 52.2 | 4.7 | 0.524 | 40 | 4/21 | 0.15 |
| Example 7 | 51.4 | 4.5 | 0.582 | 40 | 1/166 | 0.22 |

### EXAMPLE 8

A latex copolymer of vinyl acetate and vinyl neo-decanoate is prepared according to the formulation and procedure given in Table 2 using Latex Preparation Method 1, except that after the exotherm the reactor contents are allowed to react in the absence of additional monomer for a time period of 10-12 minutes, rather than 2 minutes, and except that the initial agitator speed is set to a range of 200-250 rpm. This example illustrates the use of Pluronic L-61 and Pluronic L-64, both ethylene oxide-propylene oxide block copolymers having CMC values of 0.022 wt. % and 0.139 wt. %, respectively. In addition, Rhodacal DS-4 and Cellosize QP-300 are also used. At the end of post-catalysis the residual vinyl acetate monomer level is 366 ppm. Table 6 lists properties of the resulting latex.

TABLE 6
Physical Properties of Vinyl Acetate-Vinyl neo-Decanoate
Copolymer Latex

| | | | | Brookfield | Filterables | |
|---|---|---|---|---|---|---|
| | Total | | Particle | Viscosity | (100/325 | |
| | Solids, | | Size | (LVT, #3, | mesh) | Agitator |
| Latex | (%) | pH | (micron) | 60 rpm) | (ppm) | Scrap, (g) |
| Example 8 | 49.4 | 3.6 | 0.329 | 100 | 3/23 ppm | 0.07 |

### EXAMPLE 9-1

A latex comprising a copolymer of ethylene, vinyl neo-nonanoate and vinyl neo-decanoate is prepared according to the formula and procedure given below and in Table 4. This example illustrates the use of Aerosol TR-70 to polymerize a monomer mixture of ethylene and of vinyl branched esters vinyl neo-nonanoate and vinyl neo-decanoate. In addition, Aerosol MA-80-I and Aerosol A-102 are employed.

The monomer mixture is prepared by charging the appropriate amount of each of the monomers to a vessel and mixing the contents using a variable speed agitator. The initial charge is added to a 5-gallon stainless steel reactor equipped with a DISPERSI MAX™ hollow-shaft, stainless steel double disk turbine impeller obtained from Autoclave Engineers Group, Erie, Pa. The temperature desired for the polymerization is achieved by adjusting the temperature set point in a thermostated water bath. With the reactor temperature at the desired set value, the initial monomer is charged to the reactor followed by the addition of ethylene to the desired pressure, 250 psig in this example. After the addition of ethylene, the reactor contents are allowed to thoroughly mix for 15 minutes at 300 rpm. Following this conditioning of the reactor, the initial initiator is added to the reactor followed by the initial reducer. The agitator continues to run at 300 rpm during initiation and for an additional 110 minutes, after which the speed is increased to 600 rpm. The reactor temperature increases as a result of the exotherm due to the polymerization of the initial charge. After the exotherm, the ethylene valve to the reactor is opened and the ethylene, monomer, fed catalyst and the fed reducer feeds all commence at the same time. When all the feeds are finished, the reactor contents are allowed to further react for a period of time in order to facilitate residual monomer reduction. After this post-heat step, the post-catalysis step starts. Post-oxidizer and post reducer solutions are fed over 120 minutes at 65-66° C. in order to ascertain that residual monomer levels are within desired limits. The post-catalysis step is repeated once using the same amounts of post-oxidizer and post reducer, and is then repeated again using half those amounts. At the end of this post-catalysis, the residual neo-nonanoate monomer level is 3989 ppm and the residual neo-decanoate monomer level is 4580 ppm. The reactor is cooled to below 30° C. after the post-catalysis is completed and the product is transferred to a 15 gallon drum. The product is then transferred to a 5 gallon milk can for a final post catalysis step at atmospheric pressure using 20% of the amounts of post-oxidizer and post reducer shown in Table 4. At the end of this post-catalysis, the residual neo-nonanoate monomer level is 905 ppm and the residual neo-decanoate monomer level is 1612 ppm. The properties of the latex produced are listed 5 in Table 7.

TABLE 7
Physical Properties of Ethylene-Vinyl neo-Nonanoate-Vinyl
neo-Decanoate Terpolymer Latex

| | | | | | Filterables |
|---|---|---|---|---|---|
| | Total | | | Brookfield | (40/325 |
| | Solids, | | Particle Size | Viscosity | mesh) |
| Latex | (%) | pH | (micron) | (LVT, #3, 60 rpm) | (ppm) |
| Example 9 | 40.9 | 3.8 | 0.26 | 20 | 13/68 |

### EXAMPLE 9-2

The procedure of Example 9-1 is repeated except that no ethylene is employed. The glass transition temperature, Tg, and the minimum film-forming temperature, MFFT, of the ethylene-vinyl neo-nonanoate-vinyl neo-decanoate terpolymer (from Example 9-1) and of the corresponding vinyl neo-nonanoate-vinyl neo-decanoate copolymer in the absence of ethylene (from Example 9-2) are listed in Table 8.

TABLE 8
Tg and MFFT of (Ethylene)-Vinyl neo-Nonanoate-Vinyl
neo-Decanoate Terpolymer Latex

| | Tg, | MFFT, |
|---|---|---|
| Polymer | (° C.) | (° C.) |
| Poly(vinyl neo-nonanoate/vinyl neo-decanoate) | 28.3 | 29.2 |
| Poly(vinyl neo-nonanoate/ethylene/vinyl | −2.2 | <0 |
| neo-decanoate) | | |

The Tg and the MFFT values in Table 8 suggest a considerable amount of ethylene incorporation during the polymerization of the branched esters in the presence of ethylene.

### EXAMPLE 10

The procedure of Example 9-1 is repeated using the materials and conditions shown in Table 4, and with the following additional differences. The agitator runs at 600 rpm throughout the process. With the reactor temperature at the desired set value, the reactor is evacuated to −10 psig and it is then pressurized to 10 psig using ethylene. A hold period of 5 minutes is employed after which the reactor is vented. Following this conditioning of the reactor the initial liquid phase monomer is added to the reactor followed by the addition of ethylene to the reactor until the desired pressure (250 psig) level is reached. Then, a solubilization step is followed, i.e., ethylene is allowed to solubilize in the initial monomer charge. As a result, the reactor pressure drops below the desired setting and, therefore, more ethylene is allowed into the reactor until the pressure reaches the desired level. This step is repeated until no more ethylene solubilizes in the liquid phase. Once the solubilization step is completed, the initial initiator is added to the reactor followed by the initial reducer. The reactor temperature increases as a result of the exotherm due to the polymerization of the initial charge. After the exotherm, the reactor contents are allowed to react further in the absence of any additional monomer for a period of 30 minutes. Following this, the ethylene valve is opened and ethylene is allowed into the reactor until the desired pressure level (250 psig) is reached. With the reactor pressure at the desired level and the ethylene feed cylinder valve open, the liquid monomer, the fed catalyst and the fed reducer feeds all commence at the same time. When all the feeds are finished, the reactor contents are allowed to further react for a period of time in order to facilitate residual monomer reduction. Post-oxidizer and post reducer solutions are fed over 45 minutes at 69-70° C. The post-catalysis step is repeated three times using the same amounts of post-oxidizer and post reducer, and is then repeated again over 60 minutes using a post-oxidizer solution consisting of 170.0 g deionized water and 9.5 g of t-butyl hydroperoxide and a post-reducer solution consisting of 172.0 g deionized water and 8.8 g of sodium formaldehyde sulfoxylate, solid. At the end of this post-catalysis, the residual vinyl acetate monomer level is 2801 ppm. The reactor is cooled to below 30° C. after the post-catalysis is completed and the product is transferred to a 15 gallon drum. The product is then transferred to a 5 gallon milk can for a final post catalysis step at atmospheric pressure using 60% of the amounts of post-oxidizer and post reducer shown in Table 4. At the end of this post-catalysis, the residual vinyl acetate level is 729 ppm. The properties of the latex obtained are listed in Table 9.

### EXAMPLE 11

A latex comprising a copolymer of ethylene, vinyl acetate and vinyl neo-decanoate is made by the procedure of Example 10, except that Pluronic L-61 is replaced by Pluronic F-68, the amount of Pluronic F-68 used is 64.2 grams, the amount of Rliodacal DS-4 is increased to 256.2 grams, and the post catalysis temperature is 70-71° C. At the end of the fourth post-catalysis, the residual vinyl acetate monomer level is 2722 ppm. At the end of the final post-catalysis, the residual vinyl acetate level is 971 ppm. The properties of the latex obtained are listed in Table 9.

TABLE 9
Physical Properties of Ethylene-Vinyl Acetate-Vinyl neo-Decanoate
Latexes

| | | | | | Filterables |
|---|---|---|---|---|---|
| | Tot. | | Particle | Brookfield | (100/325 |
| | Solids, | | Size | Viscosity | mesh) |
| Latex | (%) | pH | (micron) | (LVT, #3, 60 rpm) | (ppm) |
| Example 10 | 49.2 | 3.7 | 0.401 | 70 | 13/65 |
| Example 11 | 48.6 | 3.8 | 0.487 | 50 | 8/28 |

### EXAMPLE 12

Blush resistance is a test of water sensitivity. Films are drawn using a 3-mil applicator on a Lennette chart and are allowed to air dry for 16 hours. The films are then placed in an oven at 50° C. for 8 hours, and are then removed and allowed to cool. A syringe is used to deliver a drop of deionized water onto the film. Blush resistance is monitored from the time a drop is deposited on the polymer surface until the time the drop evaporates. Loss of film clarity is determined by observing for a color change in films on a black background after a drop is placed on the polymer surface. The change in clarity of the portion of the film on which the drop is deposited compared to the rest of the film is a measure of blush resistance. Table 10 shows that films made from a highly branched ester homopolymer and copolymer did not show any blushing and remain completely clear after the drop evaporates.

TABLE 10
Water Resistance of Highly Branched Ester Polymer Films

| Polymer | Film Blush |
|---|---|
| Poly(vinyl neo-decanoate) from | No |
| Ex. 4 | |
| Poly(ethylene-co-vinyl neo- | No |
| nonanoate-co-neo-decanoate) | |
| from Ex. 9-1 | |

1. A process comprising contacting a monomer composition, in which at least one monomer has a water solubility of not more than about 0.02 g/100 g water, with at least one surfactant having a critical micelle concentration of less than 0.05 wt %, the contacting taking place under emulsion polymerization conditions sufficient to polymerize the monomers of the monomer composition.

2. The process of claim 1 wherein the monomer composition comprises at least one higher branched vinyl ester.

3. The process of claim 1 wherein the monomer composition comprises ethylene.

4. The process of claim 1 wherein each monomer has a water solubility of not more than about 0.02 g/100 g water.

5. The process of claim 1 wherein the surfactant has a critical micelle concentration of less than about 0.005 wt %.

6. The process of claim 1 wherein the surfactant is sodium bis-tridecyl sulfosuccinate.

7. The process of claim 1 wherein at least one monomer is a higher branched vinyl ester selected from the group consisting of vinyl neo-nonanoate, vinyl neo-decanoate, vinyl neo-undecanoate, vinyl neo-dodecanoate, vinyl 2-ethyl hexanoate or a mixture thereof.

8. An alkene copolymer latex composition prepared from a polymerization mixture comprising:
(i) at least one alkene and at least one higher branched vinyl ester and, optionally, additional monomers;
(ii) a surfactant with a critical micelle concentration of less than 0.05 wt. %; and
(iii) water.

9. The composition of claim 8 wherein the alkene is ethylene.

10. The composition of claim 9 wherein the copolymer comprises from about 0 to about 30 weight percent of polymerized ethylene units, based on the weight of the copolymer.

11. The composition of claim 9 wherein the mixture comprises at least two monomers selected from the group consisting of vinyl neo-nonanoate, vinyl neo-decanoate, vinyl neo-undecanoate, and vinyl neo-dodecanoate.

12. A copolymer consisting essentially of, in polymerized form, a polymerization mixture comprising at least two higher branched vinyl ester monomers.

13. The copolymer of claim 12 that is a poly(vinyl neo-undecanoate-co-vinyl neo-decanoate) copolymer or a poly(vinyl neo-nonanoate-co-vinyl neo-decanoate-co-vinyl undecanoate) terpolymer, or a poly(vinyl neo-nonanoate-co-vinyl neo-decanoate) copolymer.

14. The process of claim 2 wherein the monomer composition comprises ethylene.

15. The process of claim 2 wherein each monomer has a water solubility of not more than about 0.02 g/100 g water.

16. The process of claim 14 wherein the surfactant has a critical micelle concentration of less than about 0.005 wt %.

17. The process of claim 2 wherein the surfactant has a critical micelle concentration of less than about 0.005 wt %.

18. The process of claim 3 wherein the surfactant has a critical micelle concentration of less than about 0.005 wt %.

19. The process of claim 4 wherein each monomer has a water solubility of not more than about 0.02 g/100 g water.

20. The process of claim 7 wherein the monomer composition further comprises ethylene and the surfactant is sodium bis-tridecyl sulfosuccinate.
